(19) United States
(12) Patent Application Publication
(10) Pub. No.: US 2023/0397135 A1
(43) Pub. Date: Dec. 7, 2023

(54) Small Cell Timing with External User Equipment

(71) Applicant: Celona, Inc., Campbell, CA (US)

(72) Inventors: Mehmet Yavuz, Campbell, CA (US); Srinivasan Balasubramanian, Balasubramanian, CA (US)

(21) Appl. No.: 18/323,278

(22) Filed: May 24, 2023

Related U.S. Application Data
(60) Provisional application No. 63/349,989, filed on Jun. 7, 2022.

(51) Int. Cl. H04W 56/00

(52) U.S. Cl. CPC H04W 56/001

(57) ABSTRACT

A method and apparatus are disclosed in which a first UE (User Equipment) receives signals from one or more MNO base stations. The UE synchronizes with the MNO base station timing. The first UE then communicates with a second UE over a wireless side-haul, providing the second UE with timing information derived from the MNO base station. By using the wireless side-haul, a relatively short GPIO (General Purpose Input/Output) connection over a wireline can be used to communicate the timing information from the second UE to a PTP GM (Precision Timing Protocol Grand Master). The second UE may be integrated into a cell of a communications network that contains the PTP GM. Accordingly, using the side-haul to communicate the timing information avoids cabling to a master cell.

### CLAIM OF PRIORITY TO PREVIOUSLY FILED PROVISIONAL APPLICATION-INCORPORATION BY REFERENCE

This non-provisional application claims priority to an earlier-filed provisional application No. 63/349,989 filed Jun. 7, 2022, entitled “Small Cell Timing with External User Equipment” (ATTY DOCKET NO. CEL-089-PROV) and the provisional application No. 63/349,989 filed Jun. 7, 2022, and all its contents, are hereby incorporated by reference herein as if set forth in full.

### BACKGROUND

### (1) Technical Field

The disclosed method and apparatus relate generally to communication networking. In particular, the disclosed method and apparatus relates to time synchronization of operation in Time Division Duplex mode within small cells of communication networks.

### (2) Background

For LTE and 5G small cells deployed in a local network, we need strict time synchronization to operation in TDD mode. We have two options to use as timing source for the small cells: (1) Global Positioning Systems (GPS) device; or (2) Precision Time Protocol (PTP) device. A PTP is a network element with an integrated GNSS receiver that sends PTP timing packets throughout a network. Strict timing requirements IEEE are provided by devices that adhere to a published Precision Time Protocol (PTP) standard (IEEE1588). A master-slave, packet-based protocol is defined that allows accurate propagation of the Frequency, Phase and time of day (ToD) over packet networks by exchanging accurately time-stamped “Sync messages” between network elements. When implemented properly coupled with adequate hardware, PTP can provide accuracies in the nanosecond range.

Whenever it is possible an external GPS “puck” antenna is used. The puck antenna is so called because of the general shape of the traditional puck antenna. A puck antenna is typically connected to small cells over a radio frequency (RF) cable. However, this is usually not possible for indoor deployments because among the plurality of cell, some may not have access to a clear sky for the GPS signal penetration that is required to acquire the GPS timing.

In implementations in which a GPS cannot be acquired by all of the cells, a PTP grand master (GM) can be used as the timing source. Typically, the PTP GM will be deployed in server room or an Independent Distribution Frame (IDF) room. All the small cells get timing messages from the PTP GM over an existing LAN. The source for the PTP GM to be time disciplined is a GPS/GNSS signal. During installation, an installer deploys an external GPS antenna at the roof or side of the building. An RF coax cable is run to the PTP GM sitting in the server room or IDF room. This method works for buildings that are owned by the enterprise running the network (e.g., in a factory, warehouse, hospital, etc.).

However, for places with several different enterprise occupants (e.g., multi-story shopping malls or office buildings), it is not practical to run a GPS cable from the roof of the building to private data rooms through the building. While in the example of a shopping mall, a PTP GM can be placed in a data cabinet inside each particular store, such a configuration requires each retailer to a negotiation with the shopping mall owner to place a GPS antenna on the roof top and run an RF cable to their specific retail shop inside the building.

Accordingly, it would be advantageous to provide a system that can very accurately synchronize timing for a local enterprise network without the need to access a GPS signal.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of the architecture of an enterprise network in accordance with some embodiments of the disclosed method and apparatus.

FIG. 2 is an illustration of an architecture in which two UEs are used.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

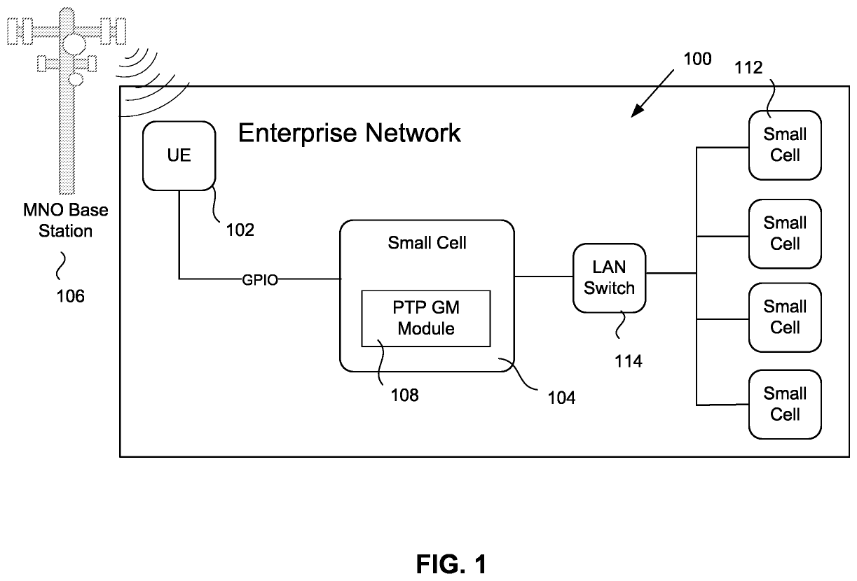

FIG. 1 is an illustration of the architecture of an enterprise network in accordance with some embodiments of the disclosed method and apparatus.

In some embodiments, a UE (User Equipment) 102 is coupled to a small cell 104 within an enterprise network 100. The UE 102 is wirelessly connected to a macro base station, such as a base station 106 of an MNO (Mobile Network Operator). The UE 102 receives timing information from the MNO base station 106. UEs camped on a base station of an MNO network receive timing information that is typically generated based on a GPS signal received by the MNO base station. In particular, in the presently disclosed method and apparatus, such timing information is received by the UE 102 from the MNO base station 106. The UE 102 in turn provides the timing information to a PTP (Precision Time Protocol) GM (Grand Master) 108 within a small cell 104 of the enterprise network 100. The PTP GM 108 within the small cell 104 of the enterprise network 100 synchronizes to the timing information received from the UE 102. The PTP GM operates essentially in accordance with the IEEE 1588 standard to provide PTP timing messages to a plurality of other small cells 112 within the enterprise network. A LAN (local area network) switch 114 allows the PTP GM 108 to distribute the timing information to each of a plurality of other small cells 112.

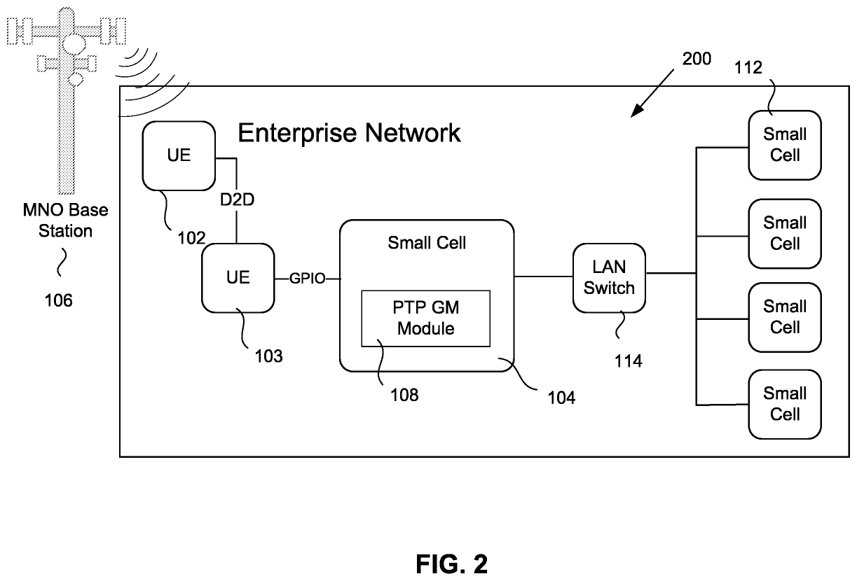

FIG. 2 is an illustration of an architecture for an enterprise network 200 in which two UEs 102, 103 are used. The first UE 102 receives the signals from one or more MNO base stations 106 and synchronizes with the MNO base station timing. The first UE 102 then communicates over a wireless side-haul (e.g., a D2D (Device to Device) communication link) with a second UE 103. The first UE 102 provides the second UE 103 with timing information derived from the MNO base station 106. By using the wireless D2D link, a relatively short GPIO (General Purpose Input/Output) connection over a wireline can be used to communicate the timing information from the second UE 103 to the PTP GM 108. In some embodiments, the second UE 103 can be integrated into the cell 104 that contains the PTP GM 108. Accordingly, using the side-haul (D2D) instead of GPIO to communicate the timing information avoids cabling to the master cell. This can be peer-to-peer or UE-to-AP (eNB/gNB) control/data communication. It should be noted that in 5G NR (5^{th} Generation New Radio), D2D has been enhanced to support broadcast/group-cast communication which in some embodiments can be used to provide better load balancing to multiple PTP master from a single timing source.

It should be noted that the timing information that the UE 102 derives from the MNO base station 106 can be determined from the acquisition signals that the MNO base station 106 sends out prior to the UE 102 acquiring the MNO base station 106. Accordingly, the UE 102 can attain the desired timing information without the need for credentials to access the MNO network (and so without the need for a SIM (subscriber Identity Module) card. Nonetheless, the UE 102 can take advantage of having MNO credentials within a SIM card (or other such device for storing credentials) to access the MNO network and attain additional benefits that come from camping onto the MNO network.

Still further, in some embodiments, one or more UEs can be used to attain timing information from one or more MNO base stations. By having a plurality of UEs and or a plurality of MNO base stations from which timing information for the PTP GM is derived, a more accurate timing base can be determined. For example, delays in communicating the timing information to the PTP GM can be determined based on differences between timing information derived from different sources.

Still further, in some embodiments, a procedure is implemented to handle a loss of signal from one or more of the MNO networks, and transition to one or more other MNO networks that are transmitting signals that one or more of the UEs can reliably receive, at least for the time during which some of the otherwise MNO network signals are unavailable.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for synchronizing communications within a communications network, the method comprising:
a) Receiving within a first UE (User Equipment) signals from at least one base station within a communications network;
b) Synchronizing the timing of the first UE with the timing of the at least one base station based on the received signals; and
c) Communicating with a second UE over a wireless side-haul from the first UE, the communication including timing information derived from the at least one base station.
